(19) United States
(12) Patent Application Publication
(10) Pub. No.: US 2025/0032915 A1
(43) Pub. Date: Jan. 30, 2025

(54) Field of View Optimization for Generated 3D Content Moment Related to Captured Gameplay Video

(71) Applicant: Sony Interactive Entertainment Inc., Tokyo (JP)

(72) Inventors: Ellana Fortuna, Austin, TX (US); Elizabeth Juenger, San Francisco, CA (US); Kristie Ramirez, San Mateo, CA (US); Geoff Norton, San Mateo, CA (US)

(21) Appl. No.: 18/361,632

(22) Filed: Jul. 28, 2023

(51) Int. Cl. A63F 13/52; G06T 7/20; G06T 7/40; G06T 17/00; G06V 10/60; G06V 20/40; H04N 23/61

(52) U.S. Cl. CPC A63F 13/52; G06T 7/20; G06T 7/40; G06T 17/00; G06V 10/60; G06V 20/44; H04N 23/61; G06V 2201/07

(57) ABSTRACT

A method for generating a view of an event in a video game is provided, including the following operations: capturing two-dimensional (2D) gameplay video generated from a session of a video game; analyzing the 2D gameplay video to identify an event occurring in a scene depicted in the 2D gameplay video and identifying one or more elements involved in said event; further analyzing the 2D gameplay video to determine 3D geometry of the scene; using the 3D geometry of the scene to generate a 3D video asset of the event that occurred in the gameplay video; generating a 2D view of the 3D video asset for presentation on a display, wherein generating said 2D view includes determining a field of view (FOV) to apply for the 2D view, the FOV being configured to include the elements involved in the event.

### BACKGROUND OF THE INVENTION

The video game industry has seen many changes over the years. As technology advances, video games continue to achieve greater immersion through sophisticated graphics, realistic sounds, engaging soundtracks, haptics, etc. Players are able to enjoy immersive gaming experiences in which they participate and engage in virtual environments, and new ways of interaction are sought. Furthermore, players may stream video of their gameplay for spectating by spectators, enabling others to share in the gameplay experience.

It is in this context that implementations of the disclosure arise.

### SUMMARY OF THE INVENTION

Implementations of the present disclosure include methods, systems and devices for generating 3D content moment from gameplay video, and providing functionality based on the 3D content moment.

In some implementations, a 3D still asset is generated from a 2D gameplay video. The 3D geometry of the scene is inferred from the 2D gameplay video, and used to generate the 3D still asset. The 3D still asset can be viewed from various perspectives, which can be user-defined or automatically determined.

In another implementation, a 3D video asset is generated from a 2D gameplay video. The 3D geometry of the scene is inferred from the 2D gameplay video, and used to generate the 3D video asset. The 3D video asset can be viewed from various perspectives, which can be user-defined or automatically determined.

In another implementation, gameplay video is analyzed to identify an event, and a 3D video asset is generated from the gameplay video in which 3D geometry of the scene where the event takes place is determined from the gameplay video. Viewing of the 3D video asset is provided with a field of view (FOV) that is optimized to capture the relevant elements which are involved in the event.

In another implementation, a 3D model of a virtual object in a 2D gameplay video is generated, and used to generate a real-world physical object resembling the virtual object (e.g. 3D printed). The 3D geometry of the virtual object is inferred from the 2D gameplay video. The virtual object can be an avatar, and may be identified from analyzing the gameplay video to identify significant moments or entities in the scene.

In some implementations, a method for generating a three-dimensional (3D) content moment from a video game is provided, including the following operations: capturing two-dimensional (2D) gameplay video generated from a session of a video game; analyzing the 2D gameplay video to determine 3D geometry of a scene depicted in the 2D gameplay video; using the 3D geometry of the scene to generate a 3D still asset of a moment that occurred in the gameplay video; storing the 3D still asset to a user account.

In some implementations, analyzing the 2D gameplay video includes identifying and tracking objects depicted in the 2D gameplay video.

In some implementations, the method further includes: providing an interface that renders a view of the 3D still asset for presentation on a display.

In some implementations, the interface enables adjustment of a perspective of the view of the 3D still asset.

In some implementations, the 3D still asset defines a 3D content model of the scene depicted in the 2D gameplay video.

In some implementations, analyzing the 2D gameplay video is further configured to determine a texture, shading or lighting of the scene, and wherein said determined texture, shading, or lighting is incorporated in the 3D still asset.

In some implementations, a non-transitory computer readable medium is provided having program instructions embodied thereon that, when executed by at least one computing device, cause said at least one computing device to perform a method for generating a three-dimensional (3D) content moment from a video game, said method including: capturing two-dimensional (2D) gameplay video generated from a session of a video game; analyzing the 2D gameplay video to determine 3D geometry of a scene depicted in the 2D gameplay video; using the 3D geometry of the scene to generate a 3D still asset of a moment that occurred in the gameplay video; storing the 3D still asset to a user account.

In some implementations, a system is provided having at least one computing device, said at least one computing device configured to perform a method for generating a three-dimensional (3D) content moment from a video game, said method including: capturing two-dimensional (2D) gameplay video generated from a session of a video game; analyzing the 2D gameplay video to determine 3D geometry of a scene depicted in the 2D gameplay video; using the 3D geometry of the scene to generate a 3D still asset of a moment that occurred in the gameplay video; storing the 3D still asset to a user account.

In some implementations, a method for generating a three-dimensional (3D) content moment from a video game is provided, including the following operations: capturing two-dimensional (2D) gameplay video generated from a session of a video game; analyzing the 2D gameplay video to determine 3D geometry of a scene depicted in the 2D gameplay video; using the 3D geometry of the scene to generate a 3D video asset of a moment that occurred in the gameplay video; storing the 3D video asset to a user account.

In some implementations, analyzing the 2D gameplay video includes identifying and tracking objects depicted in the 2D gameplay video.

In some implementations, the method further includes: providing an interface that renders a view of the 3D video asset for presentation on a display.

In some implementations, the interface enables adjustment of a perspective of the view of the 3D video asset.

In some implementations, the 3D video asset defines a 3D content model of the scene depicted in the 2D gameplay video.

In some implementations, analyzing the 2D gameplay video is further configured to determine a texture, shading or lighting of the scene, and wherein said determined texture, shading, or lighting is incorporated in the 3D video asset.

In some implementations, a non-transitory computer readable medium is provided having program instructions embodied thereon that, when executed by at least one computing device, cause said at least one computing device to perform a method for generating a three-dimensional (3D) content moment from a video game, said method including: capturing two-dimensional (2D) gameplay video generated from a session of a video game; analyzing the 2D gameplay video to determine 3D geometry of a scene depicted in the 2D gameplay video; using the 3D geometry of the scene to generate a 3D video asset of a moment that occurred in the gameplay video; storing the 3D video asset to a user account.

In some implementations, a system is provided having at least one computing device, said at least one computing device configured to perform a method for generating a three-dimensional (3D) content moment from a video game, said method including: capturing two-dimensional (2D) gameplay video generated from a session of a video game; analyzing the 2D gameplay video to determine 3D geometry of a scene depicted in the 2D gameplay video; using the 3D geometry of the scene to generate a 3D video asset of a moment that occurred in the gameplay video; storing the 3D video asset to a user account.

In some implementations, a method for generating a view of an event in a video game is provided, including the following operations: capturing two-dimensional (2D) gameplay video generated from a session of a video game; analyzing the 2D gameplay video to identify an event occurring in a scene depicted in the 2D gameplay video and identifying one or more elements involved in said event; further analyzing the 2D gameplay video to determine 3D geometry of the scene; using the 3D geometry of the scene to generate a 3D video asset of the event that occurred in the gameplay video; generating a 2D view of the 3D video asset for presentation on a display, wherein generating said 2D view includes determining a field of view (FOV) to apply for the 2D view, the FOV being configured to include the elements involved in the event.

In some implementations, analyzing the 2D gameplay video to identify the event includes identifying and tracking movements of objects depicted in the 2D gameplay video.

In some implementations, determining the FOV includes tracking movements of the elements involved in the event and adjusting a camera position or direction of the FOV so as to maintain inclusion of the elements in the FOV.

In some implementations, the elements include one or more avatars, and wherein determining the FOV includes adjusting the FOV to capture a front side of the one or more avatars.

In some implementations, the 3D video asset defines a 3D content model of the scene depicted in the 2D gameplay video.

In some implementations, analyzing the 2D gameplay video is further configured to determine a texture, shading or lighting of the scene, and wherein said determined texture, shading, or lighting is incorporated in the 3D video asset.

In some implementations, a non-transitory computer readable medium is provided having program instructions embodied thereon that, when executed by at least one computing device, cause said at least one computing device to perform a method for generating a view of an event in a video game, said method including: capturing two-dimensional (2D) gameplay video generated from a session of a video game; analyzing the 2D gameplay video to identify an event occurring in a scene depicted in the 2D gameplay video and identifying one or more elements involved in said event; further analyzing the 2D gameplay video to determine 3D geometry of the scene; using the 3D geometry of the scene to generate a 3D video asset of the event that occurred in the gameplay video; generating a 2D view of the 3D video asset for presentation on a display, wherein generating said 2D view includes determining a field of view (FOV) to apply for the 2D view, the FOV being configured to include the elements involved in the event.

In some implementations, a system is provided having at least one computing device, said at least one computing device configured to perform a method for generating a view of an event in a video game, said method including: capturing two-dimensional (2D) gameplay video generated from a session of a video game; analyzing the 2D gameplay video to identify an event occurring in a scene depicted in the 2D gameplay video and identifying one or more elements involved in said event; further analyzing the 2D gameplay video to determine 3D geometry of the scene; using the 3D geometry of the scene to generate a 3D video asset of the event that occurred in the gameplay video; generating a 2D view of the 3D video asset for presentation on a display, wherein generating said 2D view includes determining a field of view (FOV) to apply for the 2D view, the FOV being configured to include the elements involved in the event.

In some implementations, a method for generating a physical object is provided, including: capturing two-dimensional (2D) gameplay video generated from a session of a video game; analyzing the 2D gameplay video to identify a virtual object depicted in the 2D gameplay video; further analyzing the 2D gameplay video to determine 3D geometry of the virtual object; using the 3D geometry of the object to generate a 3D model of the virtual object; storing the 3D model to a user account; using the 3D model to generate a physical object resembling the virtual object.

In some implementations, generating the physical object includes applying the 3D model to a 3D printing process.

In some implementations, generating the physical object includes exporting the 3D geometry of the virtual object to a slice file for the 3D printing process.

In some implementations, the slice file is an STL file.

In some implementations, determining 3D geometry of the virtual object includes tracking the virtual object across a sequence of video frames from the 2D gameplay video.

In some implementations, the virtual object is an avatar of a user of the video game.

In some implementations, a non-transitory computer readable medium is provided having program instructions embodied thereon that, when executed by at least one computing device, cause said at least one computing device to perform a method for generating a physical object, said method including: capturing two-dimensional (2D) gameplay video generated from a session of a video game; analyzing the 2D gameplay video to identify a virtual object depicted in the 2D gameplay video; further analyzing the 2D gameplay video to determine 3D geometry of the virtual object; using the 3D geometry of the object to generate a 3D model of the virtual object; storing the 3D model to a user account; using the 3D model to generate a physical object resembling the virtual object.

In some implementations, a system is provided having at least one computing device, said at least one computing device configured to perform a method for generating a physical object, said method including: capturing two-dimensional (2D) gameplay video generated from a session of a video game; analyzing the 2D gameplay video to identify a virtual object depicted in the 2D gameplay video; further analyzing the 2D gameplay video to determine 3D geometry of the virtual object; using the 3D geometry of the object to generate a 3D model of the virtual object; storing the 3D model to a user account; using the 3D model to generate a physical object resembling the virtual object.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a process for generating a recomposed image or video using recorded gameplay video of a video game, in accordance with implementations of the disclosure.

FIG. 2 conceptually illustrates a system for generating a 3D content moment using gameplay video of a video game, in accordance with implementations of the disclosure.

FIG. 3 conceptually illustrates computer vision detection of highlights and training of a recognition model for the highlight detection, in accordance with implementations of the disclosure.

FIG. 4 conceptually illustrates 3D reconstruction of various portions of a scene over time, in accordance with implementations of the disclosure.

FIG. 5 conceptually illustrates recomposition of a field of view (FOV) in a still 3D content moment, in accordance with implementations of the disclosure.

FIG. 6 conceptually illustrates recomposition of a field of view (FOV) in a video 3D content moment, in accordance with implementations of the disclosure.

FIG. 7 conceptually illustrates a recomposition logic configured to recompose an image or video of a scene from a video game, in accordance with implementations of the disclosure.

FIG. 8 conceptually illustrates partial 3D reconstruction of a scene, and related virtual camera settings, in accordance with implementations of the disclosure.

FIG. 9 conceptually illustrates direction of a player for purposes of 3D reconstruction of a scene, in accordance with implementations of the disclosure.

FIG. 10 conceptually illustrates generation of a 3D printed object from a 3D reconstructed scene, in accordance with implementations of the disclosure.

FIG. 11 conceptually illustrates implementation of templates for 3D reconstructed content in a video game, in accordance with implementations of the disclosure.

FIG. 12 conceptually illustrates an interface for 3D content moments from gameplay of video games, in accordance with implementations of the disclosure.

FIG. 13 illustrates components of an example device 1300 that can be used to perform aspects of the various embodiments of the present disclosure.

### DETAILED DESCRIPTION OF THE INVENTION

Broadly speaking, implementations of the present disclosure include methods, systems, devices, and related computer-readable media for providing a three-dimensional (3D) moment that is reconstructed from gameplay video of a video game session. That is, gameplay video is analyzed and a 3D reconstruction of the game environment during a particular moment in the gameplay is generated. The particular moment can be a highlight or other moment of interest occurring in the gameplay that is detected. The creation of the 3D moment can be still 3D moment capturing a particular instant in the gameplay, or a video 3D moment encompassing a continuous portion of time of the gameplay. The 3D moment can be used to enable recomposed images and/or video of the gameplay, which can include generation of images or video from different perspectives, directions, splines, etc. than that of the original gameplay. This enables new views of gameplay that were not previously captured, and which can be optimized in ways that would not be possible during the original gameplay. In some implementations, recomposed views of gameplay can be defined automatically based on various automatically detected factors in the gameplay, or controlled by a user to capture the specific viewing desired by the user.

In some implementations, a 3D moment can be used to generate a real-world object, such as by generating a 3D-printed object based on the 3D geometry captured in the 3D moment.

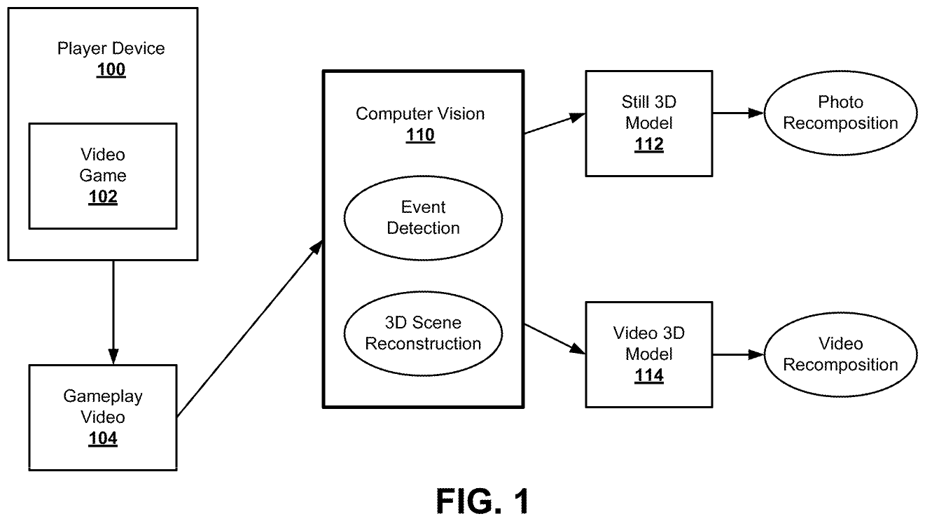

FIG. 1 conceptually illustrates a process for generating a recomposed image or video using recorded gameplay video of a video game, in accordance with implementations of the disclosure.

In the illustrated implementation, a user engages in gameplay of a video game 102 that is executed by a player device 100. Examples of player device 102 include a game console, personal computer, laptop, tablet, cellular phone, mobile device, portable gaming device, or any other computing device capable of executing a video game for gameplay. While a local device is presently described, in other implementations, the video game can be cloud executed by a cloud resource including at least a processor and memory (e.g. server computer), and streamed over the Internet to the player's local device.

With continued reference to FIG. 1, the player device 102 executes a session of the video game 102, and the execution generates, or renders, gameplay video 104 for presentation on a display (e.g. television, LCD/LED display screen or monitor, projector, etc.), which can be separate from, or integrated with, the player device 100. It will be appreciated that typically during gameplay, the user provides input to the session through the operation of one or more input devices (e.g. game controller, keyboard, mouse, touchpad, trackball, motion controller, camera, microphone, etc.), and the input is used by the executing session to update a game state of the video game. The gameplay video is continually rendered based on the game state as it is continually being updated by the executing session.

It will be appreciated that the gameplay video 104 is two-dimensional (2D) video rendered for presentation on a display in accordance with the user's particular actions during the gameplay. As such, the gameplay video 104 provides only a singular specific view at each moment in time—that being the one that was rendered during the original gameplay based on the particular inputs and actions that happened to have been taken during gameplay. It will be appreciated that it can be desirable to provide other views of the gameplay which are different than that of the gameplay video 104. In existing systems, in order to provide such alternative views, the game state is recorded and the game engine is rerun using the recorded game state, and different views can be rendered. However, this requires game developers to build in such capability and is therefore specific to each game. Some games may not offer such functionality, and it is not possible to use such a method for legacy content and video games for which the game state was never recorded.

In view of these deficiencies of existing systems, implementations of the present disclosure apply a computer vision process 110 to the gameplay video 104 to generate 3D content that is a reconstruction of the game's 3D virtual environment. The computer vision process 110 includes performing detection of events for which 3D scene reconstruction will be performed, and performing 3D scene reconstruction using the 2D gameplay video 104 for the detected events. In some implementations, the gameplay video 104 is buffered by the player device 100, and this buffered video is retrieved and used for event detection and 3D reconstruction by the computer vision process 110.

It will be appreciated that computer vision techniques for 3D reconstruction of a 3D scene based on 2D video are known in the art. Broadly speaking, such techniques are configured to extract 3D information from a sequence of video frames, including aspects of the 3D environment presented in the video, such as the 3D geometry, texture, lighting, shading, etc. Examples of techniques and principals employed in 3D reconstruction from 2D image content include motion parallax, image blur, silhouette, linear perspective, shape from shading, structure from motion, binocular disparity, etc. In some implementations, one or more artificial intelligence (AI) or machine learning models can be used to perform 3D reconstruction.

In some implementations, the computer vision process 110 is configured to generate a still 3D model 112 of the game virtual environment at a particular instant (single point in time) in the gameplay. In some implementations, a still photo/image recomposition can be performed to generate a 2D still image using the still 3D model 112. That is, a 2D still image can be rendered from the still 3D model 112, for example, by configuring a virtual camera to capture a 2D image of the still 3D model 112 from a particular perspective and with desired image capture settings.

In some implementations, the computer vision process 110 is configured to generate a video 3D model 114 of the game virtual environment throughout a portion of time (e.g. a duration of time greater than an instant, such as one or more seconds, a minute, etc.). In some implementations, a video recomposition can be performed to generate a 2D video using the video 3D model 114. That is, a 2D video can be rendered from the video 3D model 114, for example, by configuring a virtual camera to capture 2D video of the video 3D model 114 from a particular perspective (which can be moving/changing during the capture) and with desired image capture settings (which can also change during the capture). Additionally, it will be appreciated that a still 2D image can be captured from a given instant of the video 3D model 114.

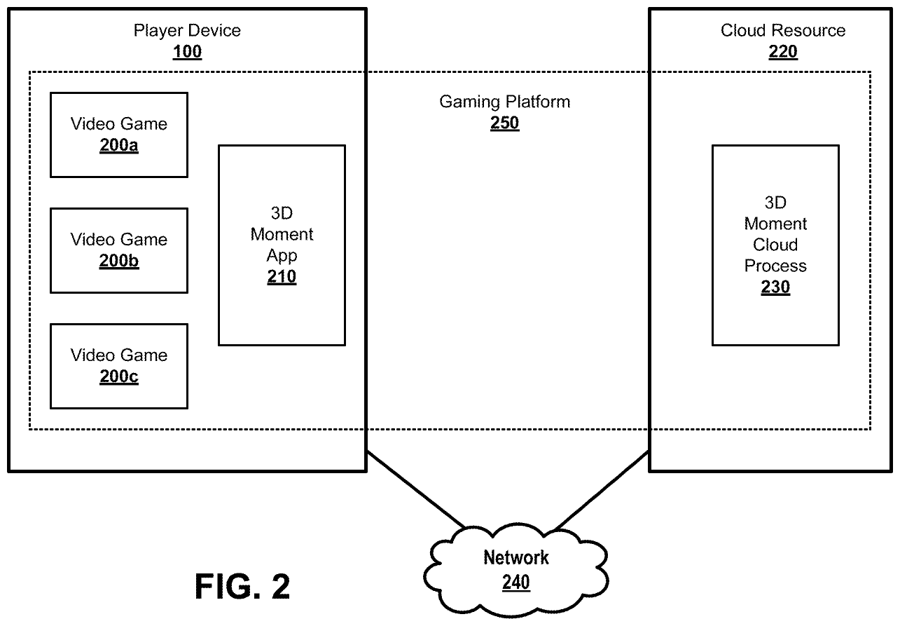

FIG. 2 conceptually illustrates a system for generating a 3D content moment using gameplay video of a video game, in accordance with implementations of the disclosure.

In the illustrated implementation, the player device 100 is capable of executing a video game for gameplay by a player, such as one of video games 200a, 200b, or 200c. In some implementations, the logic for generating a 3D content moment and providing related functionality is implemented through a 3D moment app (application) 210 that executes on the player device 100, independent of the execution of a given video game (such as one of video games 200a, 200b, or 200c). In this manner, the 3D content moment functionality of the present disclosure is provided at the level of the gaming platform 250 which defines the execution environment for the video game.

By implementing the 3D moment app at the platform level, the 3D content moment functionality is usable across different video games. Previous methods for enabling 3D content related features from prior gameplay, such as recomposing images, required implementation on the part of the game developer for a specific game, and were therefore limited to the specific game itself and its particular game engine. However, implementations of the present disclosure provide such functionality at the platform level in a game agnostic way, which does not require specific implementation by game developers for specific video games or game engines, and can be used across different video games.

In some implementations, the processing for enabling the 3D content moment in accordance with implementations of the disclosure is performed locally at the player device 100. In other implementations, at least some of the processing for enabling the 3D content moment is implemented by a 3D moment cloud process 230, which executes on a cloud resource 220 and communicates over network 240 with the 3D moment app 210. It will be appreciated that tasks such as video processing and 3D reconstruction can be computationally intensive, and therefore, it can be useful to leverage cloud processing to provide faster processing of such tasks.

By way of example without limitation, in some implementations, the gameplay video is initially recorded at the player device 100, and then uploaded to the cloud resource 220 for processing by 3D moment cloud process 230. For example, this can include processing by the computer vision process 110 to develop the still 3D model 112 or video 3D model 114. In some implementations, the still or video 3D model is downloaded to the player device 100 and subsequently utilized locally by the 3D moment app 210 to enable related functionality such as still image or video recomposition.

In other implementations, the division in processing between local and cloud resources can be handled in other ways. In some implementations, the processing is handled substantially entirely locally at the player device 100. In some implementations, processing that is performed locally at the player device 100 may further be configured to run as a background process or during periods of otherwise low resource use, e.g. when a video game is not being executed at the player device 100 or when sufficient memory and processing resources are available. In some implementations, assets generated from 3D models at the player device 100 are uploaded for storage to a cloud-based portion of the gaming platform 250, such as to a user account that is stored by cloud resource 220.

In some implementations, the processing is handled primarily in the cloud by the 3D moment cloud process 230, with the 3D moment app 210 providing a front-end interface for enabling access to 3D moment functionality that is executed in the cloud.

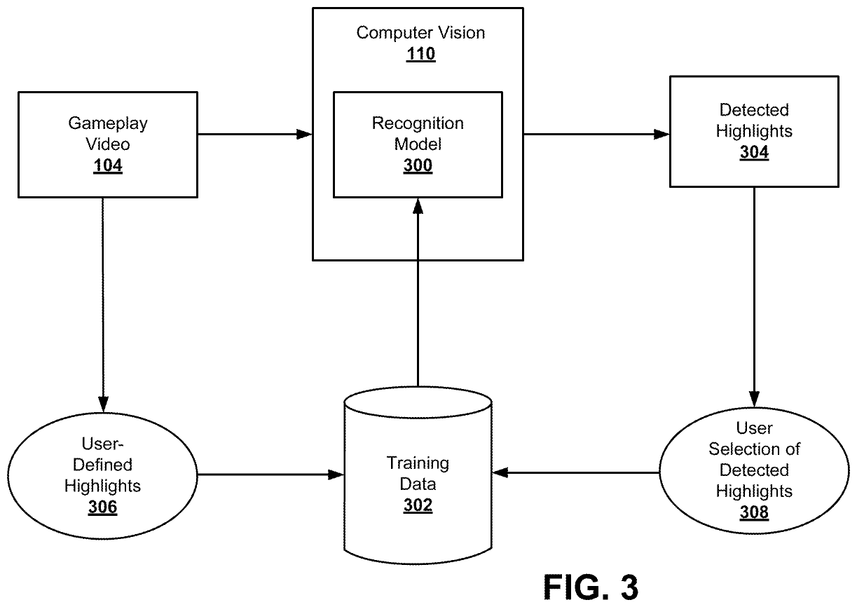

FIG. 3 conceptually illustrates computer vision detection of highlights and training of a recognition model for the highlight detection, in accordance with implementations of the disclosure.

As described, the gameplay video 104 is processed by the computer vision process 110 to recognize and detect highlights or other moments of interest occurring in the gameplay. In some implementations, the computer vision process 110 employs a recognition model 300, such as an AI or machine learning model, configured to detect highlights occurring in the gameplay video 104. In various implementations, the recognition model 300 is configured to detect certain key moments based on various factors or recognized activity or scenes in the gameplay video 104, such as the following: movement activity (e.g. of avatars, characters, vehicles, objects, etc.), fighting activity, achievement activity, scene changes (e.g. as indicator of highlight occurring prior to scene change), statistical changes (e.g. changes in points, energy, resources, ammunition, etc.), recognized locations or settings or scenes, recognized characters or objects (e.g. boss character, enemy), text (e.g. text generated by the game, text chat messages by players, etc.)

In some implementations, the recognition model 300 is configured to detect highlights based at least in part on audio information in the gameplay video 104 (which can be in addition to the image information). It will be appreciated that various sounds can be recognized as indicative of gameplay highlights, such as sounds associated with particular activity in the game (e.g. explosions, sounds of a boss character/enemy, sounds of a setting/location/scene, etc.), speech generated by the game, speech by one or more of the players of the game (e.g. words, expressions, exclamations, etc.), background music/soundtrack, etc.

As the recognition model 300 is applied to the gameplay video 104, so a series of detected highlights 304 is generated. In some implementations, the detected highlights 300 can be defined by images or video clips from the gameplay video 104 which have been determined to be highlights or other interesting activity occurring the gameplay, and for which a 3-D content moment may be generated. In some implementations, the detected highlights 304 are presented to the user for selection, such as through a user interface rendered by the 3-D moment app 210. As indicated at reference 308, the user engages in selection of one or more of the detected highlights to perform additional related activity, such as recomposition of an image or video as described herein.

It will be appreciated that the user selection of the detected highlights is itself an indication of what the user considers to be a highlight from the gameplay. As such, this selection activity can serve as a form of feedback for improving the recognition model 300. Thus, in some implementations, the user selection from amongst the detected highlights 304 is processed into the training data 302 that is used to train the recognition model 300. In this manner, the ability of the recognition model 300 to detect gameplay highlights can be refined and improved over time based on the user selection.

In some implementations, there can be user-defined highlights 306 from the gameplay video 104. For example, the 3-D moment app 210 can provide a user interface configured to enable the user to identify a segment or time point in the gameplay video 104 that the user considers to be a highlight. These user-defined highlights 306 can also be used as training data 302 for the recognition model 300. In some implementations, characteristics and features of such user-defined highlights 306 are extracted as part of the training process, so that the recognition model 300 is trained to detect activity having similar characteristics and features, and identify such activity as a highlight in the gameplay video 104.

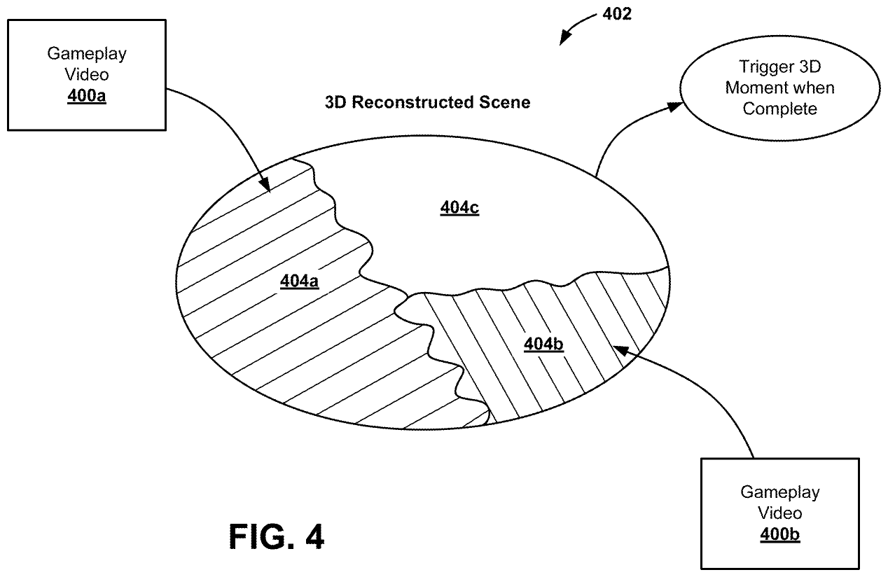

FIG. 4 conceptually illustrates 3D reconstruction of various portions of a scene over time, in accordance with implementations of the disclosure.

In the illustrated implementation, a 3D reconstructed scene 402 is conceptually shown. The 3D reconstructed scene 402 can be defined by a still 3D model or video 3D model as discussed above. In some implementations, the 3D reconstructed scene 402 can be defined to represent a specific location or region of the virtual environment of the video game. In some implementations, the 3D reconstructed scene 402 can be defined to represent changes which occur in the location or region of the virtual environment. In some implementations, the 3D reconstructed scene can be defined to represent shifting or changing of the location or region of the virtual environment over time.

It will be appreciated that the 3D reconstructed scene 402 may not be completed on the basis of a single gameplay video. For example, a portion 404a of the scene 402 is reconstructed based on processing gameplay video 400a, whereas a portion 404b of the scene is reconstructed based on processing of another gameplay video 400b. The gameplay videos 404a and 404b can be captured from different instances/sessions of the video game. It will be appreciated that different gameplay videos will have different content, and may enable 3D reconstruction of different regions of the game's virtual environment.

In some implementations, the gameplay videos 404a and 404b are generated from gameplay by different players in different sessions of the video game. It will be appreciated that different players will engage in gameplay of the same regions of the game's virtual environment, and therefore, gameplay videos from different players can be used to enable 3D reconstruction of a given scene. In some implementations, the gameplay videos 404a and 404b are generated from gameplay by different players participating in the same multi-player session of the video game. It will be appreciated that in such a multi-player session, different players will have different perspectives of the virtual environment, and their recorded gameplay will afford 3D reconstruction of various portions of the scene accordingly. Different gameplay videos or portions thereof may complement each other to enable 3D reconstruction of a particular region, or they may enable 3D reconstruction of different regions or overlapping regions of the virtual environment.

With continued reference to the illustrated implementation of FIG. 4, it is shown that a region 404c has yet to be reconstructed. Accordingly, in some implementations, when the 3D reconstruction of the scene 402 is completed, then this triggers 3D moment functionality for the user in accordance with implementations of the disclosure. For example, a notification can be surfaced to the user when the scene reconstruction is complete, indicating that the 3D moment is available for viewing, image/video recomposition, 3D printing, or other 3D moment functions.

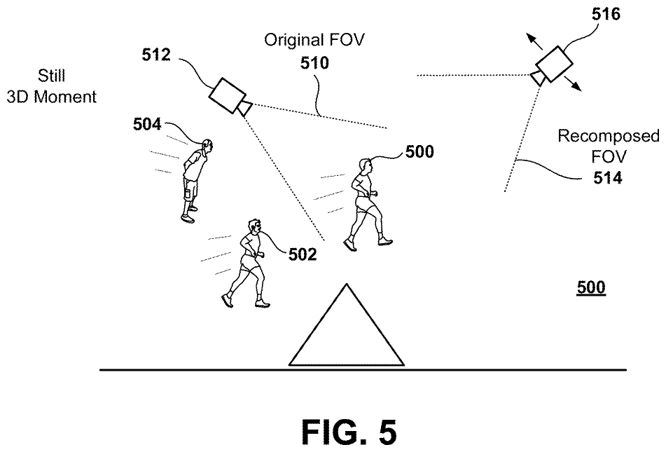

FIG. 5 conceptually illustrates recomposition of a field of view (FOV) in a still 3D content moment, in accordance with implementations of the disclosure.

In the illustrated implementation, a still 3D content moment 500 is shown, consisting of a 3D reconstruction of a still scene of gameplay, in accordance with implementations of the disclosure. In the scene, various characters 500, 502 and 504 are shown in an action pose. The original field of view (FOV) 510 of the gameplay video during game execution was taken from the perspective of a virtual camera 512 having a position and direction as shown. However, because a 3D reconstruction has been produced, a recomposed FOV 514 can be provided from a different perspective, namely that of a virtual camera 516 having a position and direction as shown, which are different from the original FOV.

It will be appreciated that the recomposed FOV 514 is different than the original FOV 510, and can be optimized or adjusted so as to provide an enhanced view of the scene. For example, while the original FOV 512 may have captured only the character 500 from the back side, the recomposed FOV 514 can be configured to capture all of the characters 500, 502, and 504 from the front side so as to show the characters' faces. It will be appreciated that the recomposed FOV 514 can be tailored to include or exclude various elements in the scene, and can be defined from a customized positioning and direction of the virtual camera 516. Furthermore, in some implementations, additional image or virtual camera parameters can be set, such as zoom, exposure, brightness, contrast, white balance, levels and curves, aperture/depth of field, etc.

In some implementations, the recomposed FOV is automatically determined by the system. In some implementations, the recomposed FOV is set or adjusted by the user. In some implementations, a user interface is provided to enable setting of the FOV, and may enable real-time previewing of the image resulting from the FOV as it is adjusted. When the FOV is set as desired, then a 2D image based on the FOV is determined. In various implementations, the recomposed image can be locally stored, uploaded to cloud storage, shared through a social network or other communications platform, etc.

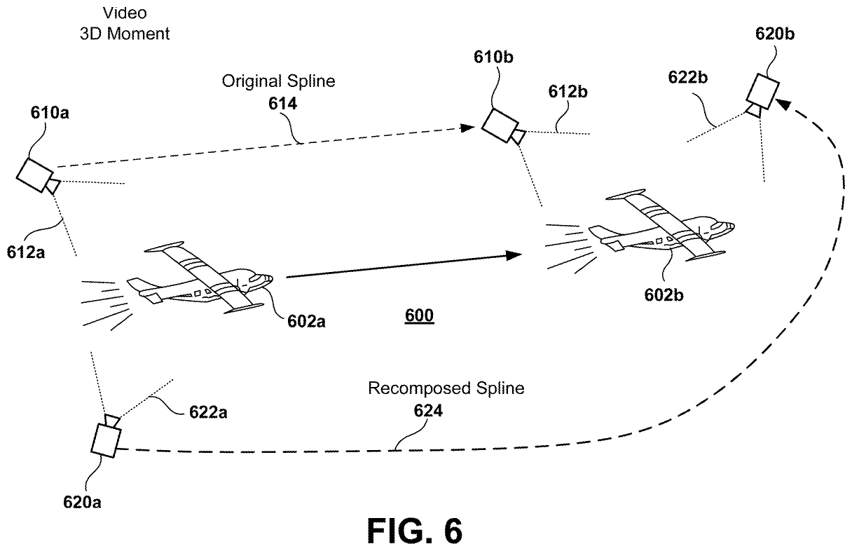

FIG. 6 conceptually illustrates recomposition of a field of view (FOV) in a video 3D content moment, in accordance with implementations of the disclosure.

In the illustrated implementation, a video 3D content moment 600 is shown, consisting of a 3D reconstruction of a video scene of gameplay, in accordance with implementations of the disclosure. In the scene, an aircraft 602a is shown moving from a first location to a second location shown at reference 602b. The original field of view (FOV) 612a of the gameplay video during game execution was taken from the perspective of a virtual camera 610a having a position and direction as shown. And during the original gameplay, virtual camera 610a moves along the original spline 614, to a second position shown by reference 610b and having a FOV 612b.

However, because a 3D reconstruction has been produced, a recomposed FOV and spline can be provided from a different perspective, namely that of a virtual camera 620a having an initial position and direction as shown, to provide a FOV 622a, which is different from the initial original FOV. The virtual camera moves along a recomposed spline 624 to a second position and direction shown by reference 620b, affording a FOV 622b.

It will be appreciated that the recomposed virtual camera FOV and spline are different than the original virtual camera FOV and spline, and yields a recomposed video providing a different depiction of the scene than that of the original gameplay video. In this manner, the recomposed video can be optimized or adjusted so as to provide an enhanced view of the scene. For example, while the original video's FOV may have captured only the aircraft 602a from the back side in a following manner, the recomposed video's FOV can be configured to capture in a moving and more cinematic manner, for example, shifting from one side of the aircraft and moving around to another side of the aircraft, also providing viewing of the surrounding environment from various perspectives in the process. It will be appreciated that the recomposed FOV can be tailored to include or exclude various elements in the scene, and can be defined from a customized positioning and direction and spline of the virtual camera. Furthermore, in some implementations, additional image or virtual camera parameters can be set or changed, such as zoom, exposure, brightness, contrast, white balance, levels and curves, aperture/depth of field, etc.

In some implementations, the recomposed FOV is automatically determined by the system. In some implementations, the recomposed FOV is set or adjusted by the user. In some implementations, a user interface is provided to enable setting of the FOV, and may enable real-time previewing of the image or video resulting from the FOV as it is adjusted. When the FOV is set as desired, then a 2D image based on the FOV is determined. In various implementations, the recomposed video can be locally stored, uploaded to cloud storage, shared through a social network or other communications platform, etc.

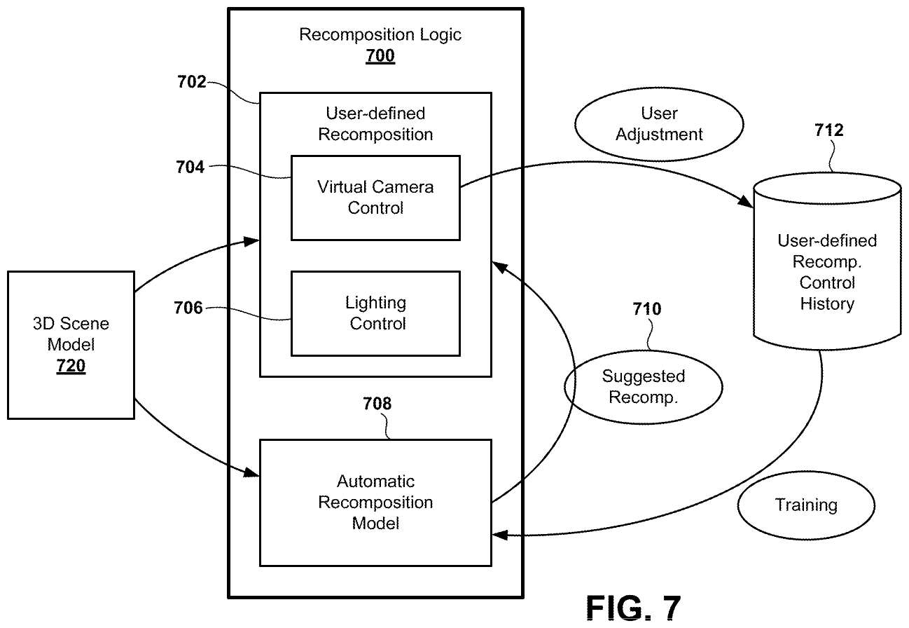

FIG. 7 conceptually illustrates a recomposition logic configured to recompose an image or video of a scene from a video game, in accordance with implementations of the disclosure.

As has been described, a 3D scene model 720 can be reconstructed from gameplay video, and may include 3D geometry of the scene, textures, shading, lighting, and other information about the scene extracted from the gameplay video. Recomposed images or video can be developed from the 3D scene model 720 by manipulating a virtual camera to provide a different field of view of the 3D scene model 720. Accordingly, in some implementations, recomposition logic 700 is implemented to enable recomposition of the FOV to provide recomposed images or video.

In some implementations, user-defined recomposition logic 702 is configured to enable user control and adjustment of the virtual camera, including virtual camera control logic 704 enabling user-defined adjusting of the position, direction, and movement (spline) of the virtual camera. Additionally, the virtual camera control logic 704 can further provide for adjustment of virtual camera settings such as zoom, aperture, shutter speed, ISO, exposure, white balance, etc. In some implementations, lighting control logic 706 is provided to enable user-defined control and adjustment of the lighting of the 3D scene model 720. In some implementations, this can include adjusting existing light sources in the 3D scene model 720, or adding new lighting to the scene, such as spot lighting, diffuse lighting, etc. It will be appreciated that dramatic compositional effects can be achieved by enabling the user to adjust the lighting in the scene for a recomposed image or video.

In some implementations, an automatic recomposition model 708 (e.g. an AI or machine learning model) is configured to automatically provide a suggested recomposition 710 of the scene. That is, the recomposition model 708 provides a suggested virtual camera positioning, direction, spline, and other settings for the 3D scene model 720, to provide a suggested image or video recomposition. In some implementations, the user may make further adjustments to the suggested recomposition, using the aforementioned user-defined recomposition logic 702 and related tools.

The automatic recomposition model 708 can be configured to determine a suggested recomposition based on various factors in the 3D scene model 720 or the gameplay video, including information about the scene determined from the recognition model 300 previously described, analysis of the 3D scene model 720 itself, identification of objects in the scene (e.g. avatars, characters, boss characters, faces, weapons, vehicles, etc.), movement of objects in the scene, etc. For example, the automatic recomposition model 708 may be trained or otherwise configured to include in the FOV objects that are involved in a particular event of interest, such as including characters or avatars that are involved in a given event. Extending the concept, the automatic recomposition model 708 may be trained or otherwise configured to include in the FOV relevant views of the objects involved in the event, e.g. showing faces of characters or avatars, showing objects that carrying out actions of interest, etc. It will be appreciated that in the case of video recomposition, the automatic recomposition model 708 can be configured to maintain inclusion of the relevant objects in the FOV through adjustment of the movement/spline and direction of the virtual camera. In some implementations, the automatic recomposition model 708 may be trained or otherwise configured to emphasize objects of interest in the suggested recomposition, such as through adjustment of lighting, vignetting, aperture or depth of field adjustment, etc.

Furthermore, in some implementations, user adjustments to the suggested recompositions, as well as original user-defined recompositions, can be stored to a user-defined recomposition control history 712, and this information can be used to further train the automatic recomposition model 708 to improve the recomposition suggestions.

In some implementations, the automatic recomposition model 708 is trained using video game related information, such as cut-scenes from a given video game, video game related media, etc. In this way, the automatic recomposition model 708 can be trained to imitate the cinematic style of the video game itself.

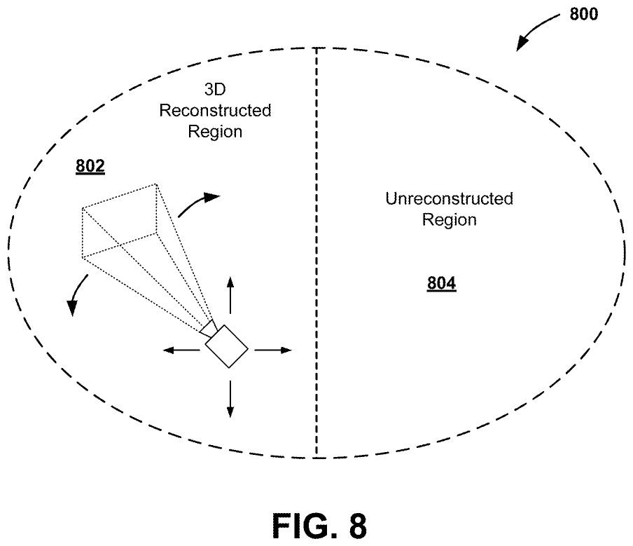

FIG. 8 conceptually illustrates partial 3D reconstruction of a scene, and related virtual camera settings, in accordance with implementations of the disclosure.

In the illustrated implementation, 3D reconstruction of a scene 800 has occurred to a partial extent, but is not complete. As such, there is a reconstructed region 802 and an unreconstructed region 804 of the scene. As has been noted, over time as more gameplay video becomes available, then additional portions of the scene 800 can be reconstructed. However, even with partial reconstruction of the scene, it is nonetheless possible to offer recomposition features to the user for the partially reconstructed portion of the scene. Thus, in some implementations, recomposed views for images or video and enabled in the reconstructed region 802, but virtual camera settings can be limited based on the configuration of the reconstructed region 802 and the unreconstructed region 804.

For example, in the illustrated implementation, a virtual camera 806 FOV may be limited to viewing of the reconstructed region 802, so that viewing of the unreconstructed region 804 is not allowed. In some implementations, this can include limiting the positioning of the virtual camera 806 to be substantially in the reconstructed region 802 or within a portion thereof, limiting the direction of the virtual camera 806 to be directed towards the reconstructed region 802 and not towards the unreconstructed region 804 (such as by limiting the angular extent of the virtual camera's allowed direction (e.g. horizontal or vertical angular extent)), limiting an amount of zoom of the virtual camera 806 that is offered, or otherwise limiting the parameters of the virtual camera 806 so that its FOV does not attempt to capture the unreconstructed region 804.

In some implementations, the FOV of the virtual camera 806 is allowed to partially include a portion of the unreconstructed region 804, and when this occurs, the portion of the view is inferred using a generative AI or other technique.

In yet another implementation, some or all of the unreconstructed region 804 is inferred using a generative AI or other technique (inferring the 3D geometry, texture, shading, lighting, etc.). In this manner, the limitations on the virtual camera 806 as described above may be reduced to allow at least partial viewing of the unreconstructed region 804 that has been inferred using the generative AI. In some implementations, the inferred portion is identified and tracked, and may be partially or fully replaced by 3D reconstruction based on additional gameplay video when such becomes available.

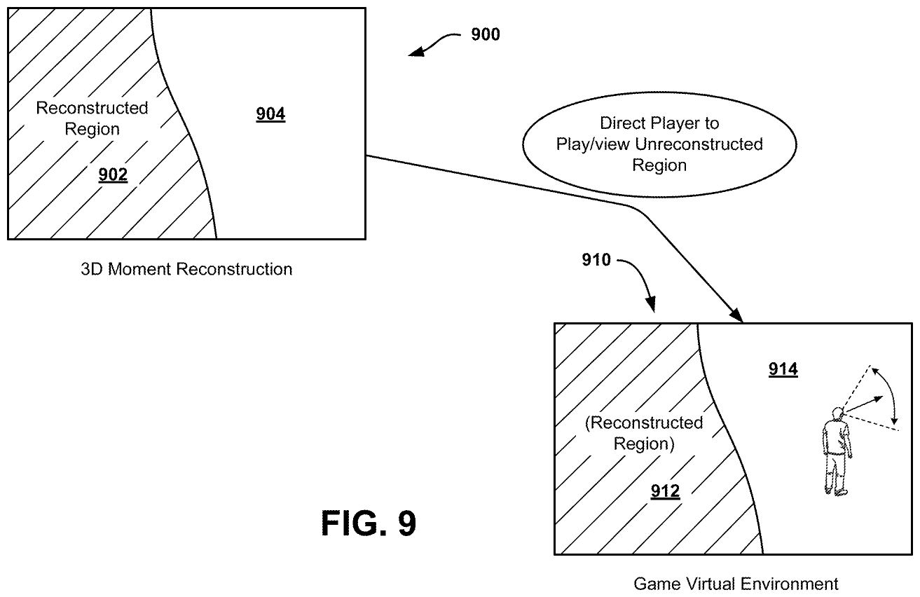

FIG. 9 conceptually illustrates direction of a player for purposes of 3D reconstruction of a scene, in accordance with implementations of the disclosure.

In the illustrated implementation, a scene 900 has been partially 3D reconstructed, including a reconstructed region 902 and an unreconstructed region 904. In some implementations, in order to complete the 3D reconstruction of the scene, the system is configured to direct the player to go back into the game and conduct gameplay in the region corresponding to the unreconstructed region 904. That is, in the game's virtual environment 910, there is a region 912 corresponding to the reconstructed region 902 that has already been 3D reconstructed, and a region 914 corresponding to the unreconstructed region 904 for which additional information is needed. The player can be encouraged to carry out gameplay and viewing in the region 914 so as to provide additional gameplay video to enable 3D reconstruction of the region 914.

Extending the concept further, in some implementations, the system can suggest a path or direction for the user to move and view, so as to supply gameplay video of a specific region of the game virtual environment. In some implementations, the suggested path or direction can be implemented in the form of graphical elements or overlays providing visual indicators to the user to follow, such as arrows, lines, footsteps, target waypoints, etc. In this manner, the system may direct the user to provide the needed information in the form of gameplay video that is required to enable completion of 3D reconstruction of the scene.

It will be appreciated that often gameplay viewing occurs from a vantage point that is located behind a player's avatar, and accordingly viewing of the front of the player's avatar may not occur very often. Thus, in some implementations, the player is encouraged to maneuver their in-game camera view to capture views of the front of their avatar, or views from various directions so as to capture comprehensive viewing of their avatar from multiple directions. A 3D reconstruction of the player's avatar can be carried out, and then in some implementations, when 3D reconstruction of a scene is being carried out, missing information about the player's avatar at a particular moment can be inferred based on the reconstructed player avatar, or the reconstructed player avatar can be inserted at the appropriate location in the 3D reconstructed scene. While the player avatar has been described the current implementation, a similar process can be applied for other objects or characters in the video game.

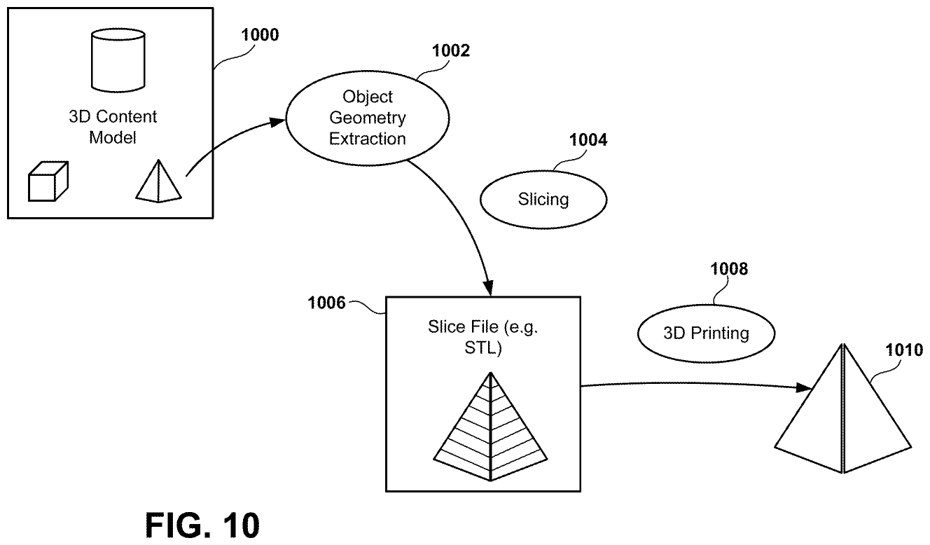

FIG. 10 conceptually illustrates generation of a 3D printed object from a 3D reconstructed scene, in accordance with implementations of the disclosure.

In the illustrated implementation, a 3D content model 1000 is reconstructed from gameplay video as previously described. The 3D content model 1000 includes 3D geometry of various objects appearing in a scene of the gameplay. In some implementations, the user is enabled to generate a physical object based on the 3D reconstructed information. For example, the 3D geometry of a selected object can be extracted (ref. 1002), and a slicing process 1004 can be applied to generate a slice file 1006 (e.g. STL, OBJ, 3MF, PLY, etc.) based on the extracted 3D geometry. A 3D printer can be used to 3D print (ref. 1008) a physical object 1010 using the slice file 1006. In this manner, the physical object 1010 is created resembling an object from the video game.

While 3D printing has been described, in other implementations, other types of physical implementation can be created based on the 3D geometry that has been generated. In some implementations, a 3D crystal engraving process (e.g. laser engraving) is used to generate a crystal engraving based on the 3D geometry of at least a portion of the 3D content model 1000. In some implementations, holographic images or projections can be generated based on the 3D geometry of at least a portion of the 3D content model.

In some implementations, a user interface is provided to enable the user to select a portion or specific object from within the 3D content model 1000 in order to generate a physical object. For example, the interface can enable the user to select an object, and choose to export the 3D geometry of the object in a relevant file format to enable generation of the physical object, such as by converting the 3D geometry to a slice file for 3D printing as described above. It will be appreciated that in addition to 3D geometry information, other relevant information for the desired output can be extracted, such as color information, texture information, etc.

In another implementation, other game-related objects can be instantiated as physical objects. For example, the 3D geometry of a trophy or medal can be inferred and used to generate a 3D printed version of the trophy or medal in accordance with the above.

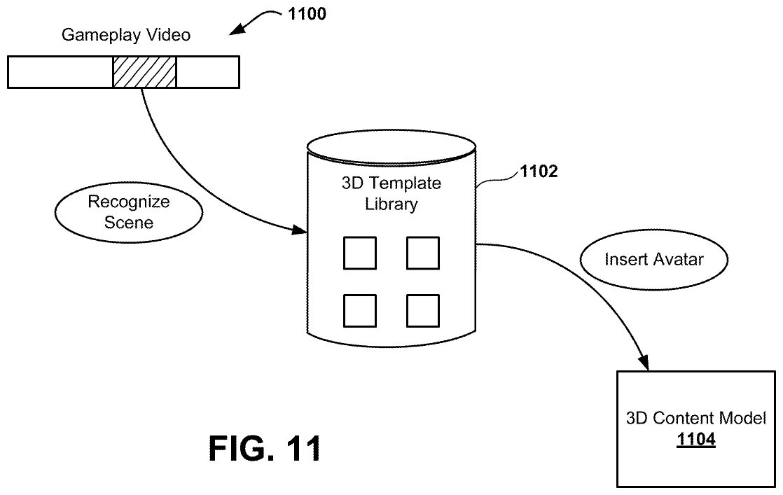

FIG. 11 conceptually illustrates implementation of templates for 3D reconstructed content in a video game, in accordance with implementations of the disclosure.

It will be appreciated that in a given video game, players may engage in interesting gameplay activity in the same scenes, locations, settings, etc. within the context of the video game. Accordingly, a given scene may be substantially similar from one player to the next, and accordingly, reconstructed 3D content of the scene can be reused for different gameplay videos by different players or the same player. In some implementations, templates of specific scenes or locations or regions within a video game's virtual environment are generated, and stored to a 3D template library 1102. It will be appreciated that a given template includes 3D content of a given scene, including 3D geometry, texture, shading, lighting, etc. and can be generated from one or more gameplay videos in accordance with the principles of the present disclosure.

When a gameplay video 1100 is analyzed, a portion of the gameplay video 1100 may be recognized as depicting a scene for which a template exists. In some implementations, an image matching technique is used to match images from the gameplay video portion against representative images of content of templates in the 3D template library 1102. In some implementations, a partial 3D reconstruction fingerprint is performed and matched against the templates in the 3D template library 1102.

When a scene in the gameplay video 1100 is recognized as corresponding to a given template, then the matching template is obtained, and the unique aspects from the gameplay video 1100 are extracted and inserted into the template, to define the 3D content model 1104 for that portion of the gameplay video 1100. For example, in some implementations, the player avatar is extracted from the gameplay video 1100 or otherwise obtained, and inserted into the matching template to define the 3D content model 1104 for the relevant scene of the gameplay video 1100.

Thus, in accordance with implementations of the disclosure, by creating reusable templates for 3D content, the amount of processing required for 3D scene reconstruction is reduced, and the 3D reconstruction of a scene can be performed more quickly as a result.

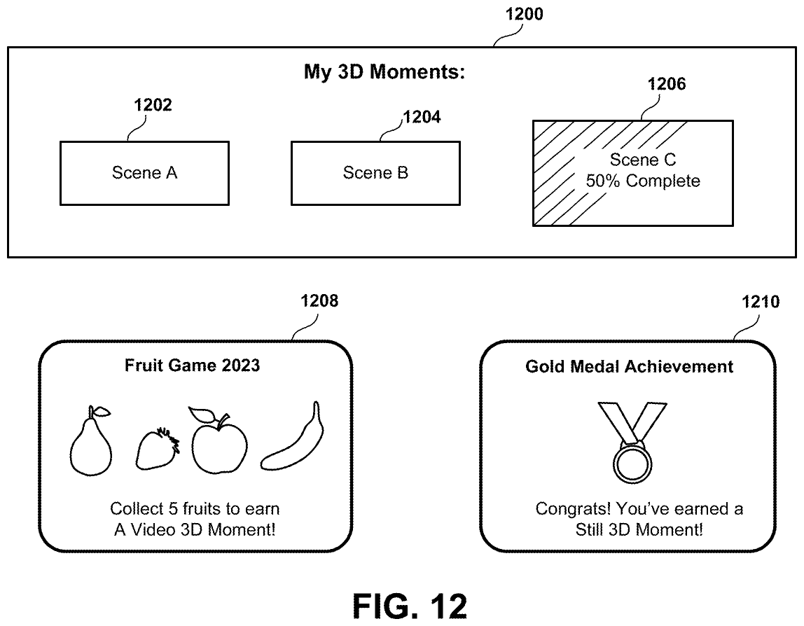

FIG. 12 conceptually illustrates an interface for 3D content moments from gameplay of video games, in accordance with implementations of the disclosure.

In the illustrated implementation, a user interface is shown, including a section 1200 providing access to the user's 3D content moments. These include 3D reconstructed scenes, defined by 3D content model 1202 for a “Scene A,” 3D content model 1204 for a “Scene B,” and 3D content model 1206 for a “Scene C.” The 3D content model 1206 is partially complete as shown, indicating that further gameplay video is required in order to finish the 3D reconstruction of the scene.

In some implementations, users may earn the ability to generate or unlock a 3D content moment, for example, through achievement on the gaming platform, or achievement within a particular video game. For example, in the illustrated implementation as shown at ref. 1208, the user is informed that by collecting or earning enough items in the video game, they may earn a video 3D moment. Or as shown at ref. 1210, the user has achieved a particular medal (e.g. on the gaming platform), and as such has earned a still 3D moment. Other examples of gaming platform or video game related achievements through which 3D content moment functionality may be earned can include the following: earning sufficient rewards/points/status in a rewards system (which in some implementations may be redeemed for a 3D content moment), completing a sufficient amount of time of gameplay, achieving a streak of consecutive days/weeks/etc. of gameplay, achieving a trophy or other accomplishment, reaching a level of a video game, performing a sufficient amount of participation in a game-related forum or social network, purchasing a sufficient number of video games on the gaming platform, etc.

It will be appreciated that 3D reconstruction can require significant cloud compute resources, and therefore it is useful to limit access to the 3D content moment functionality of the present disclosure through implementing reward systems for earning the 3D content moment functionality. In other implementations, users may pay for the ability to generate a 3D content moment based on their gameplay.

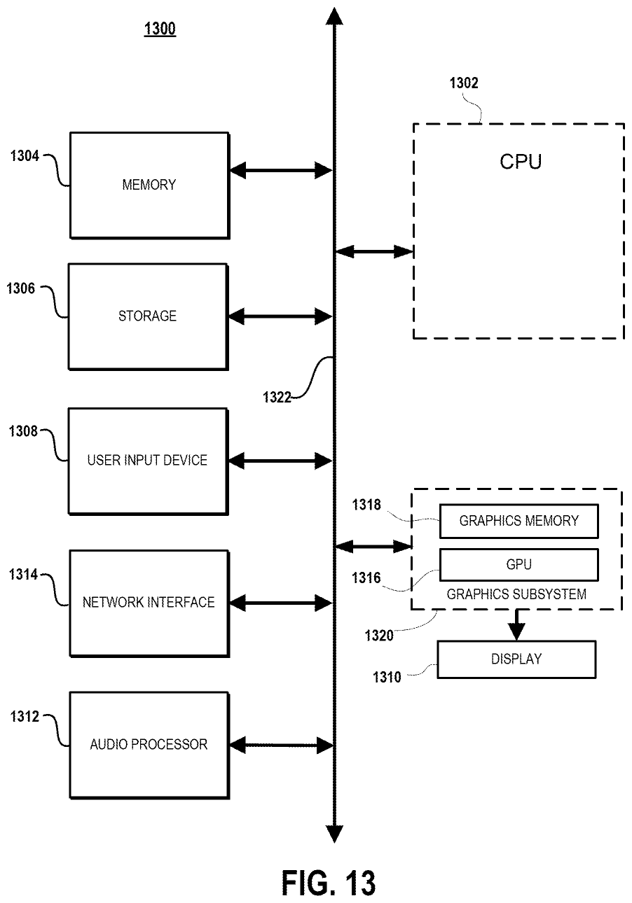

FIG. 13 illustrates components of an example device 1300 that can be used to perform aspects of the various embodiments of the present disclosure. This block diagram illustrates a device 1300 that can incorporate or can be a personal computer, video game console, personal digital assistant, a server or other digital device, suitable for practicing an embodiment of the disclosure. Device 1300 includes a central processing unit (CPU) 1302 for running software applications and optionally an operating system. CPU 1302 may be comprised of one or more homogeneous or heterogeneous processing cores. For example, CPU 1302 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 1300 may be a localized to a player playing a game segment (e.g., game console), or remote from the player (e.g., back-end server processor), or one of many servers using virtualization in a game cloud system for remote streaming of gameplay to clients.

Memory 1304 stores applications and data for use by the CPU 1302. Storage 1306 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1308 communicate user inputs from one or more users to device 1300, examples of which may include keyboards, mice, joysticks, touch pads, touch screens, still or video recorders/cameras, tracking devices for recognizing gestures, and/or microphones. Network interface 1314 allows device 1300 to communicate with other computer systems via an electronic communications network, and may include wired or wireless communication over local area networks and wide area networks such as the internet. An audio processor 1312 is adapted to generate analog or digital audio output from instructions and/or data provided by the CPU 1302, memory 1304, and/or storage 1306. The components of device 1300, including CPU 1302, memory 1304, data storage 1306, user input devices 1308, network interface 1310, and audio processor 1312 are connected via one or more data buses 1322.

A graphics subsystem 1320 is further connected with data bus 1322 and the components of the device 1300. The graphics subsystem 1320 includes a graphics processing unit (GPU) 1316 and graphics memory 1318. Graphics memory 1318 includes a display memory (e.g., a frame buffer) used for storing pixel data for each pixel of an output image. Graphics memory 1318 can be integrated in the same device as GPU 1308, connected as a separate device with GPU 1316, and/or implemented within memory 1304. Pixel data can be provided to graphics memory 1318 directly from the CPU 1302. Alternatively, CPU 1302 provides the GPU 1316 with data and/or instructions defining the desired output images, from which the GPU 1316 generates the pixel data of one or more output images. The data and/or instructions defining the desired output images can be stored in memory 1304 and/or graphics memory 1318. In an embodiment, the GPU 1316 includes 3D rendering capabilities for generating pixel data for output images from instructions and data defining the geometry, lighting, shading, texturing, motion, and/or camera parameters for a scene. The GPU 1316 can further include one or more programmable execution units capable of executing shader programs.

The graphics subsystem 1314 periodically outputs pixel data for an image from graphics memory 1318 to be displayed on display device 1310. Display device 1310 can be any device capable of displaying visual information in response to a signal from the device 1300, including CRT, LCD, plasma, and OLED displays. Device 1300 can provide the display device 1310 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (Saas). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for generating a view of an event in a video game, comprising:
capturing two-dimensional (2D) gameplay video generated from a session of a video game;
analyzing the 2D gameplay video to identify an event occurring in a scene depicted in the 2D gameplay video and identifying one or more elements involved in said event;
further analyzing the 2D gameplay video to determine 3D geometry of the scene;
using the 3D geometry of the scene to generate a 3D video asset of the event that occurred in the gameplay video;
generating a 2D view of the 3D video asset for presentation on a display, wherein generating said 2D view includes determining a field of view (FOV) to apply for the 2D view, the FOV being configured to include the elements involved in the event.

2. The method of claim 1, wherein analyzing the 2D gameplay video to identify the event includes identifying and tracking movements of objects depicted in the 2D gameplay video.

3. The method of claim 1, wherein determining the FOV includes tracking movements of the elements involved in the event and adjusting a camera position or direction of the FOV so as to maintain inclusion of the elements in the FOV.

4. The method of claim 1, wherein the elements include one or more avatars, and wherein determining the FOV includes adjusting the FOV to capture a front side of the one or more avatars.

5. The method of claim 1, wherein the 3D video asset defines a 3D content model of the scene depicted in the 2D gameplay video.

6. The method of claim 1, wherein analyzing the 2D gameplay video is further configured to determine a texture, shading or lighting of the scene, and wherein said determined texture, shading, or lighting is incorporated in the 3D video asset.

7. A non-transitory computer readable medium having program instructions embodied thereon that, when executed by at least one computing device, cause said at least one computing device to perform a method for generating a view of an event in a video game, said method including:
capturing two-dimensional (2D) gameplay video generated from a session of a video game;
analyzing the 2D gameplay video to identify an event occurring in a scene depicted in the 2D gameplay video and identifying one or more elements involved in said event;
further analyzing the 2D gameplay video to determine 3D geometry of the scene;
using the 3D geometry of the scene to generate a 3D video asset of the event that occurred in the gameplay video;
generating a 2D view of the 3D video asset for presentation on a display, wherein generating said 2D view includes determining a field of view (FOV) to apply for the 2D view, the FOV being configured to include the elements involved in the event.

8. The non-transitory computer readable medium of claim 7, wherein analyzing the 2D gameplay video to identify the event includes identifying and tracking movements of objects depicted in the 2D gameplay video.

9. The non-transitory computer readable medium of claim 7, wherein determining the FOV includes tracking movements of the elements involved in the event and adjusting a camera position or direction of the FOV so as to maintain inclusion of the elements in the FOV.

10. The non-transitory computer readable medium of claim 7, wherein the elements include one or more avatars, and wherein determining the FOV includes adjusting the FOV to capture a front side of the one or more avatars.

11. The non-transitory computer readable medium of claim 7, wherein the 3D video asset defines a 3D content model of the scene depicted in the 2D gameplay video.

12. The non-transitory computer readable medium of claim 7, wherein analyzing the 2D gameplay video is further configured to determine a texture, shading or lighting of the scene, and wherein said determined texture, shading, or lighting is incorporated in the 3D video asset.

13. A system comprising at least one computing device, said at least one computing device configured to perform a method for generating a view of an event in a video game, said method including:
capturing two-dimensional (2D) gameplay video generated from a session of a video game;
analyzing the 2D gameplay video to identify an event occurring in a scene depicted in the 2D gameplay video and identifying one or more elements involved in said event;
further analyzing the 2D gameplay video to determine 3D geometry of the scene;
using the 3D geometry of the scene to generate a 3D video asset of the event that occurred in the gameplay video;
generating a 2D view of the 3D video asset for presentation on a display, wherein generating said 2D view includes determining a field of view (FOV) to apply for the 2D view, the FOV being configured to include the elements involved in the event.

14. The system of claim 13, wherein analyzing the 2D gameplay video to identify the event includes identifying and tracking movements of objects depicted in the 2D gameplay video.

15. The system of claim 13, wherein determining the FOV includes tracking movements of the elements involved in the event and adjusting a camera position or direction of the FOV so as to maintain inclusion of the elements in the FOV.

16. The system of claim 13, wherein the elements include one or more avatars, and wherein determining the FOV includes adjusting the FOV to capture a front side of the one or more avatars.

17. The system of claim 13, wherein the 3D video asset defines a 3D content model of the scene depicted in the 2D gameplay video.

18. The system of claim 13, wherein analyzing the 2D gameplay video is further configured to determine a texture, shading or lighting of the scene, and wherein said determined texture, shading, or lighting is incorporated in the 3D video asset.
